(19) United States
(12) Patent Application Publication
(10) Pub. No.: US 2015/0068357 A1
(43) Pub. Date: Mar. 12, 2015

(54) BICYCLE CABLE SLEEVE

(71) Applicant: Yuan-Hung WEN, Chang Hua County (TW)

(72) Inventor: Yuan-Hung WEN, Chang Hua County (TW)

(21) Appl. No.: 14/025,819

(22) Filed: Sep. 12, 2013

(51) Int. Cl. F16C 1/20

(52) U.S. Cl. CPC F16C 1/205
USPC 74/502.5

(57) ABSTRACT

The present invention provides a bicycle cable sleeve, including an inner tube, a fiber layer and an outer cladding layer. The inner tube is provided for allowing a bicycle cable to dispose in, and the fiber layer is formed by a plurality of strand wires arranged and entangled around the inner tube. Each strand wire is made from glass fiber. An outer surface of the fiber layer is formed with a plurality of concave slits between each two neighboring strand wires. The outer cladding layer covers the outer surface of the fiber layer, and part of the outer cladding layer fills the concave slits up. Therefore, the bicycle cable sleeve of the present invention has better pliability and endurance.

### BACKGROUND OF THE INVENTION

1. Field of the Invention

The present invention relates to a bicycle cable sleeve.

2. Description of the Prior Art

Generally speaking, the brake system or transmission system of a bicycle is controlled by users via a brake cable or a shift cable connecting to the handles. Users' forces can be transmitted through the brake cable or shift cable to the brake system or the transmission system to slow the speed down, brake, or the like.

Therefore, bicycle cables like brake cable or shift cable are essential. The bicycle cables have to been connected from the handles to the functioning area (for example, the brake system), and the bicycle cables will go through the bicycle frames and extend a distance. The bicycle cables are often adequately bent to match with the bicycle frames. However, when the bicycle cables are pulled, it is harder for bent bicycle cables to transmit forces precisely, and the bicycle cables can even be stuck and broken and thus be risky when riding bikes.

Regarding the above-mentioned disadvantage, a sleeve of bicycle cable is developed for allowing bicycle cables to dispose in and move in it axially. With this device, the moving routes of bicycle cables can be made sure and positioned, so the situations that bicycle cables are stuck or ill-functioned could be prevented, and the bicycle cables could be protected from impact, abrasion or the damage caused by rain or sunlight.

Generally speaking, the sleeve includes an inner layer formed by entangled metal cables and a cladding layer covering the cables, and the cladding layer is often made from polypropylene to provide better weather-endurance and stronger structure; however, the metal cables have strong structure but not enough pliability. When being bent too much, the metal cables could break.

The present invention is, therefore, arisen to obviate or at least mitigate the above-mentioned disadvantages.

### SUMMARY OF THE INVENTION

The main object of the present invention is to provide a bicycle cable sleeve which can provide better pliability and endurance.

The main object of the present invention is to provide a bicycle cable sleeve, including an inner tube, a fiber layer and an outer cladding layer.

The inner tube is provided for allowing a bicycle cable to dispose in, and the fiber layer is formed by a plurality of strand wires arranged and entangled around the inner tube. Each strand wire is made from glass fiber. An outer surface of the fiber layer is formed with a plurality of concave slits between each two neighboring strand wires. The outer cladding layer made from nylon covers the outer surface of the fiber layer, and part of the outer cladding layer fills the concave slits up.

The bicycle cable sleeve of the present invention uses glass fiber strand wires to entangle, so it has better pliability. The outer cladding layer made from nylon can connect with the glass fiber better to make the whole structure more stable. Furthermore, because nylon is highly weather-enduring, impact-resistant and friction-resistant, the present invention becomes more endurable.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of the present invention;

FIG. 2 is a perspective breakdown drawing of the present invention;

FIG. 3 is a cross-sectional view of the present invention;

FIG. 4 is a drawing showing the present invention in use.

### DETAILED DESCRIPTION OF THE PREFERRED EMBODIMENTS

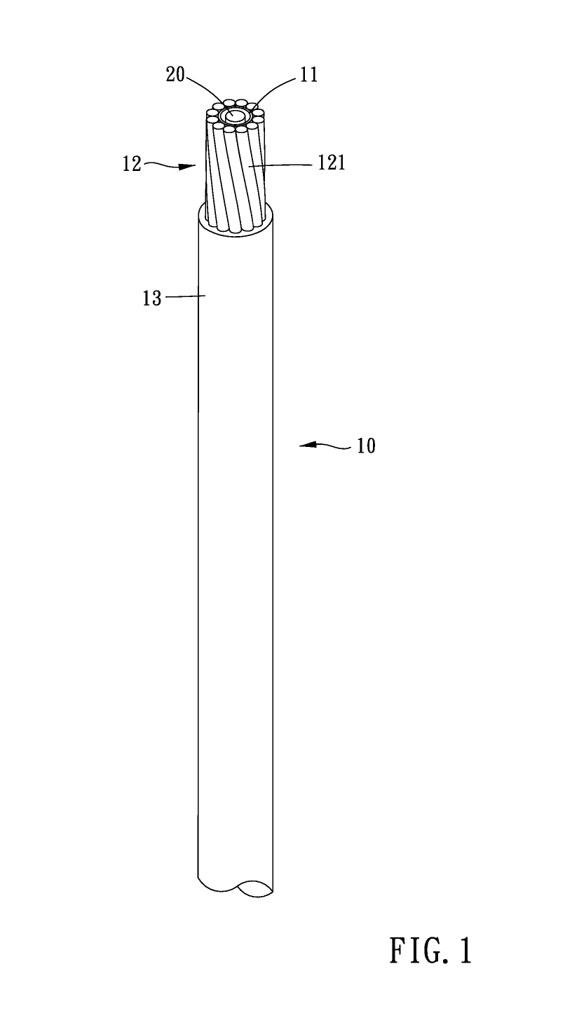

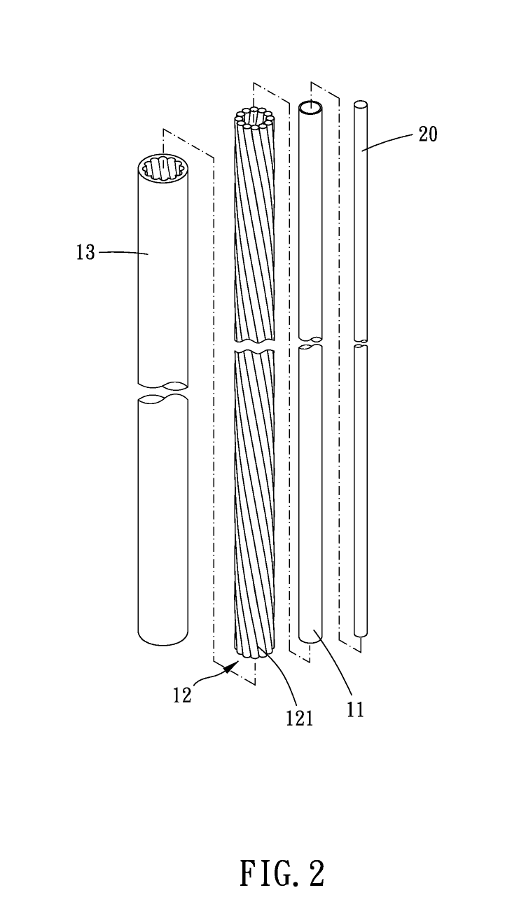

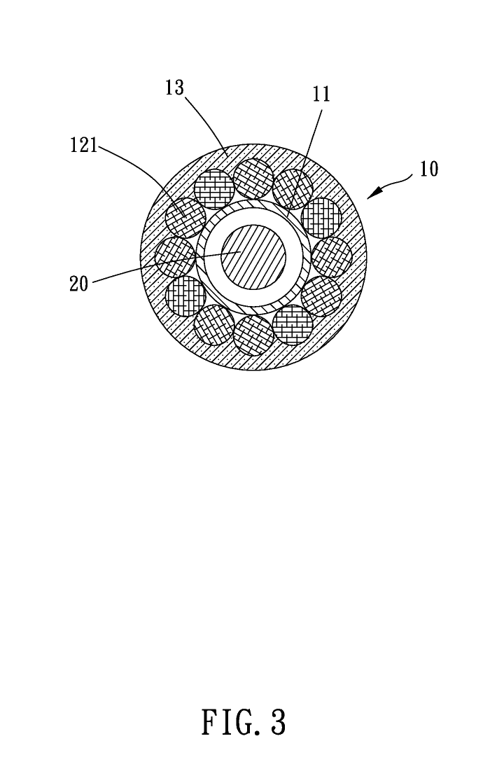

As shown in FIGS. 1 to 3, the present invention provides a bicycle cable sleeve 10, including an inner tube 11, a fiber layer 12 and an outer cladding layer 13.

The inner tube 11 has a cavity provided for allowing a bicycle cable 20 to dispose in, and the inner tube 11 is preferably made from polyethylene, Teflon or plastic steel. The fiber layer 12 is formed by a plurality of strand wires 121 arranged and entangled around the inner tube 11. Each strand wire 121 is made from glass fiber. An outer surface of the fiber layer 12 is formed with a plurality of concave slits between each two neighboring strand wires 121. More specifically, the strand wires 121 are generally cylindrical; therefore, even if the strand wires 121 are tightly entangled with each other, there will still be a plurality of concave slits formed on the outer surface. The outer cladding layer 13 covers the outer surface of the fiber layer 12, and part of the outer cladding layer 13 fills the concave slits up. The outer cladding layer 13 is made from nylon, and preferably, the outer cladding layer 13 is made by covering the outer surface of the fiber layer 12 with melted nylon and cooling it down. The melted nylon will flow and permeate into the concave slits so as to fill up the concave slits and make the outer cladding layer and the fiber layer stick together.

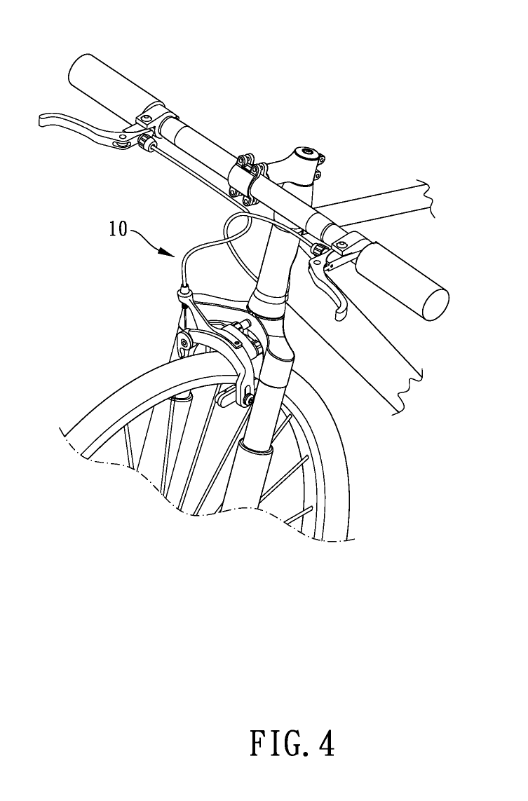

Please refer to FIGS. 1 to 3 along with FIG. 4 for actual practice. The bicycle cable sleeve 10 of the present invention is provided to be disposed around a bicycle cable 20, the cable for transmitting forces such as a brake cable or a shift cable. The bicycle cable 20 needs to be connected to the brake system and other devices, so the bicycle cable sleeve 10 has to be extended in accordance with the bicycle cable 20 and adequately bent to match with the extending route of the bicycle cable. Since the fiber layer 12 of the present invention is made from glass fiber, the pliability of the bicycle cable sleeve is better than that of the sleeve entangled with metal cables. The outer cladding layer 13 is made from nylon, so the adhesive force with the fiber layer 12 is greater. Therefore, when the bicycle cable sleeve is bent, the outer cladding layer 13 and the fiber layer 12 will not easily fall off from each other; hence, the integrality of the structure can be maintained.

Given the above, through the fiber layer made from glass fiber, the bicycle cable sleeve of the present invention has better pliability. In addition, the outer cladding layer made from nylon provides stronger adhesive force with the glass fiber, so the outer cladding layer can stick with the fiber layer tightly. The outer cladding layer further has good scratch-proof, weather-enduring and impact-resistant abilities, so the fiber layer, the inner tube and the bicycle cable disposed in the outer cladding layer are well protected and thus become more endurable. Besides, the present invention replaces metal with glass fiber to reduce weight.

Although particular embodiments of the invention have been describe in detail for purposes of illustration, various modifications and enhancements may be made without departing from the spirit and scope of the invention. Accordingly, the invention is not to be limited except as by the appended claims.

What is claimed is:

1. A bicycle cable sleeve, including:
an inner tube, provided for a bicycle cable to dispose through;
a fiber layer, formed by a plurality of strand wires which are arranged and entangled around the inner tube, each strand wire made of glass fiber, an outer surface of the fiber layer formed with a plurality of concave slits between each two neighboring strand wires;
an outer cladding layer, covering the outer surface of the fiber layer, and part of the outer cladding layer filling the concave slits up.

2. The bicycle cable sleeve of claim 1, wherein the inner tube is made from polyethylene.

3. The bicycle cable sleeve of claim 1, wherein the inner tube is made from Teflon.

4. The bicycle cable sleeve of claim 1, wherein the inner tube is made from plastic steel.

5. The bicycle cable sleeve of claim 1, wherein the outer cladding layer is made by covering the outer surface of the fiber layer with melted nylon and cooling it down.
